(19) United States
(12) Patent Application Publication
(10) Pub. No.: US 2002/0088687 A1
(43) Pub. Date: Jul. 11, 2002

(54) Device for grouping of articles

(76) Inventors: Matthias Hofmann, Lich (DE); Bruno Baumeister, Heimbach (DE); Walter Baur, Gruendau (DE)

Correspondence Address: David G. Boutell, Flynn, Thiel, Boutell & Tanis, P.C., 2026 Rambling Road, Kalamazoo, MI, 49008-1699, US

(21) Appl. No.: 10/043,570

(22) Filed: Jan. 10, 2002

(30) Foreign Application Priority Data
Jan. 11, 2001 (DE) 101 00 969.0

(51) Int. Cl. B65G 47/31

(52) U.S. Cl. 198/462.1

(57) ABSTRACT

In order to be able to change in a simple manner the distance d between two transverse walls (8) of the compartmented belt (6) during a rotative movement of the compartmented belt (6) about plural guide rollers, it is suggested to change both an angle a, which lies between a transverse wall (8) and a vertical (9) of an element (10) which holds the transverse wall (8), and also an angle βwhich lies between a straight line (11) connecting two of the axes of rotation (12, 13) of guide rollers (4, 5) and a straight line (14) extending through one of the axes of rotation (12).

### FIELD OF THE INVENTION

The invention relates to a device for grouping of articles, for example bags, which are supplied or delivered in groups to a collecting mechanism, comprising a compartmented belt which is supported for movement on guide rollers and has a plurality of transverse walls. Each article is moved between two mutually adjacent transverse walls at a feed-in station in order to supply the articles to the collecting mechanism by means of the compartmented belt.

### BACKGROUND OF THE INVENTION

A device of this type is known from the EP 0 700 832 A. The compartmented belt rotates in this device about four guide rollers. Each chain link of the compartmented belt has a transverse wall mounted thereon. These transverse walls are designed spring-like in order to feed bags housed between the transverse walls, and without overly compressing them, to the collecting mechanism. A pressure is, however, applied to the bags at the collecting mechanism which is in the form of a conveyor belt, by each pair of mutually adjacent transverse walls and a carrier on the conveyor belt, particularly onto a group of side-by-side positioned bags, in order to obtain a uniform bag thickness and in order to be able to subsequently place this precisely dimensioned group into a close fitting box.

The conventional device has the disadvantage that a change in the distance between two adjacent transverse walls can occur only in a technically relatively expensive manner. The springy plates in addition have the disadvantage that they have a different effect on different fill materials. Thus bags with a relatively easily deformable fill material have a tendency to be flattened and bags with a fill material which is relatively difficult to deform are flattened less so that heavy fill material can press apart the springy plates. The spring force may, however, not be too great so that a simple removal of the bags from the compartmented belt at the collecting mechanism will occur.

### SUMMARY OF THE INVENTION

The basic purpose of the invention is to provide a device of the above-described type in such a manner that the distance between two adjacent transverse walls can be changed in a simple manner.

In order to be able to change in a simple manner the distance d between two transverse walls of the compartmented belt during a rotative movement of the compartmented belt about plural guide rollers, it is suggested to change both an angle α, which lies between a transverse wall and a normal to an element which holds the transverse wall, and also an angle β, which lies between a straight line connecting two of the axes of rotation of guide rollers and a straight line extending through one of the axes of rotation. These angles α and β are adjusted by means of an adjusting mechanism in order to change the distance between two mutually adjacent transverse walls.

The device of the invention has the advantage that the distances between the transverse walls can be easily changed by adjusting the angles α and β. When in addition a rigid, not springy connection exists between the elements and the transverse walls, then it is possible to adjust the angle α precisely without that a springiness could change this angle.

When the transverse walls are designed rigidly, thus not resiliently, then the adjustment of a constant angle α valid over the entire height of the transverse wall is possible in a safe and reliable manner. A springiness in the area of the transverse walls, regardless in which manner, would result in an inexactness with regard to the angle α.

An exchangeable plug connection is suited as an easily operable adjusting mechanism for the angle α. After the exchange of a plug connection which provides a specified angle α for a transverse wall with a plug connection which provides a different angle α, the transverse wall connected to the plug connection is differently aligned.

The adjusting mechanism for the angle α is also suited as an angularly adjustable mount for the transverse wall. This mounting can, for example, provide several locking positions for the angle α. In addition it would be possible to adjust the mounting without steps.

When a mechanism for pivoting one axis of rotation about the other axis of rotation is provided as the adjusting mechanism for the angle β, which mechanism in addition has a locking device for the pivoted axis of rotation, then the angle β can be adjusted without causing the tension of the compartmented belt to be changed. The locking device is used to hold the pivoted axis of rotation in a desired position which the angle β has reached. The two parallel strands of the compartmented belt are in the case of a compartmented belt rotating merely about two guide rollers aligned parallel with respect to the connecting straight line between the axes of rotation of the guide rollers. However, the angle adjustments are also suited for compartmented belts rotating about three or more guide rollers. In the case of four guide rollers, the compartmented belt describes, for example, a parallelogram or merely a square. Here an axis of rotation of one guide roller must be pivoted with respect to an axis of rotation of a guide roller arranged directly therebefore or thereafter in order to align the strand extending between two successive guide rollers with respect to a new angle β. The parallelism between the straight line and the strand is, however, valid only for the case where the two guide rollers have the same diameter.

When the compartmented belt rotates in a vertical plane, then the vertical is suited as a straight line. The compartmented belt could, however, also rotate in a horizontal plane.

When a preferably continuously operated supply mechanism for supplying the articles is provided at the feed-in station, and in addition the transverse wall oriented adjacent at the feed-in station is aligned parallel with respect to the mechanism, then the articles are moved particularly quickly, and without great mechanical stress to these articles, into the compartmented belt. A detector at the feed-in station can be utilized in order to recognize supplied articles in order to regulate through a regulating mechanism the precise time the articles are fed into the forward moving compartmented belt.

### BRIEF DESCRIPTION OF THE DRAWINGS

The invention will be described in greater detail hereinafter in connection with one exemplary embodiment illustrated in the drawings, in which:

FIG. 1 is a side view of a compartmented belt rotating about two guide rollers, the transverse walls of which compartmented belt form a finite angle α with respect to a normal to the plural elements each holding a respective transverse wall, and whereby the axis of rotation of the lower guide roller is pivotal about the axis of rotation of the upper guide roller in order to adjust a specified angle β between the vertical and the straight line connecting the two axes of rotation;

FIG. 2 is a simplified illustration of a fragment of one of the parallel strands of the device of FIG. 1 at specified angles α and β, and at a specified distance d between each pair of mutually adjacent transverse walls; and

FIG. 3 is a simplified illustration of the subject matter of FIG. 2, however, at different angles α and β, which result in a different distance d.

### DETAILED DESCRIPTION

A compartmented belt 6 supported for movement about two guide rollers 4, 5 so that the reaches or strands thereof are inclined is provided in a device 1 for grouping of bags 2 which are delivered in groups to a collecting mechanism 3 for the purpose of transporting the bags 2 from a feed-in station 7 to a collecting mechanism 3. The compartmented belt 6 has a plurality of transverse walls 8. One bag 2 is moved between each pair of mutually adjacent transverse walls 8 of the compartmented belt 6, which walls move in this embodiment clockwise. The collecting mechanism 3 houses a conveyor belt 24 with spaced apart carriers 25.

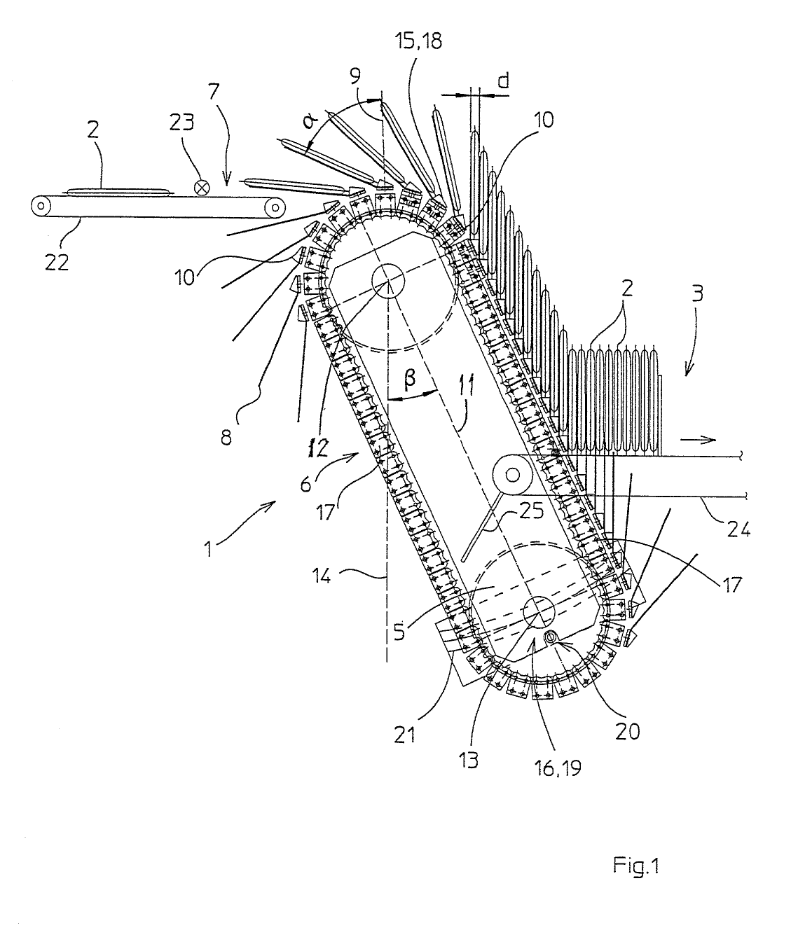

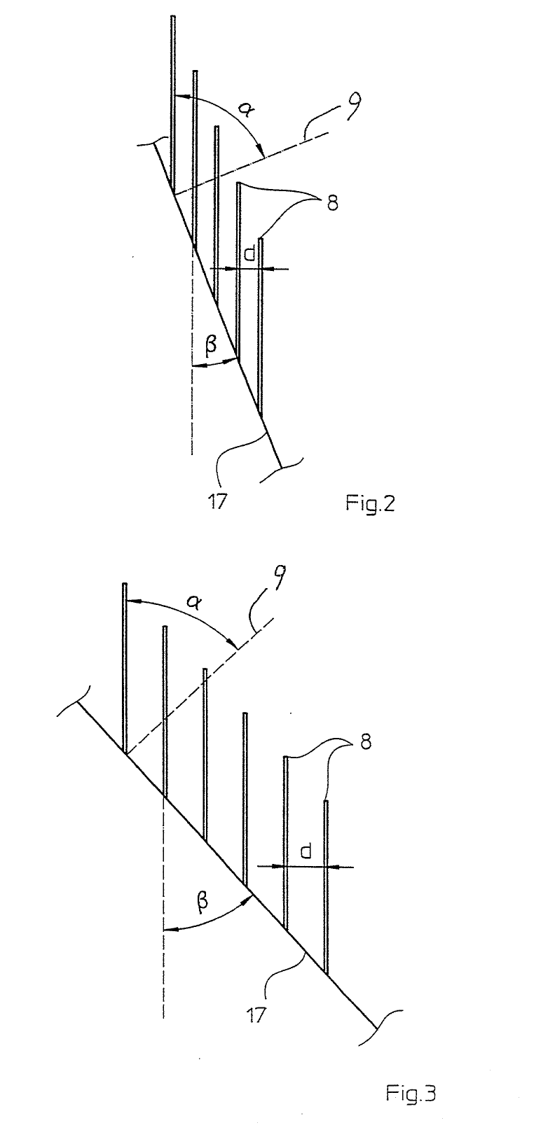

Each transverse wall 8 is aligned at a specified angle α with respect to a normal 9 to the strand 17 of the belt 6. Elements 10 secured to the belt 6 rigidly hold the respective transverse walls 8 on the belt 6. The straight line 11 extending between the axes of rotation 12, 13 of the two guide rollers 4, 5 and a vertically oriented straight line 14 extending through the upper axis of rotation 12 describe an angle β (FIG. 2). Both angles α and β can be adjusted for the purpose of changing the distance d between each pair of mutually adjacent pair of transverse walls 8 by means of an adjusting mechanism 15, 16 (FIG. 1, FIG. 3). The distance d is constantly and sensibly provided along the two parallel strands 17 of the compartmented belt 6.

An exchangeable plug connection 18 is provided to connect each transverse wall 8 to a respective element 10. When it is desired to change or adjust the angle α, a different set of transverse walls 8, each having a plug-in connector 18 with the chosen angle α built into it, is installed on the elements 10 to replace the previous set of transverse walls removed from the elements 10. A mechanism 19 for pivoting the lower axis of rotation 13 about the upper axis of rotation 12 is provided as the adjusting mechanism 16 for the angle β. The angle β is changed in response to such pivoting. The pivoted lower axis of rotation 13 can be fixed by means of a locking device 20 in its new position on the pivot path 21.

The transverse walls 8 are designed absolutely rigidly and not resiliently so that the angle α is valid for the entire transverse wall areas. A continuously moving supply mechanism 22 for supplying the articles is provided at the feed-in station 7. The transverse wall 8 oriented at the feed-in station 7 is aligned parallel with respect to the article feed direction provided by the supply mechanism 22 in order to guarantee an interference-free article feeding into the compartmented belt 6. For the purpose of adjusting the movements of the supply mechanism 22 and of the compartmented belt 6, a detector 23 recognizes each arriving bag 2.

The angles α and β are adjusted when a new distance d between the transverse walls 8 is supposed to be provided (FIGS. 2 and 3). A new distance d is chosen prior to bags 2 having a different thickness being placed into boxes. The distance d is always chosen in such a manner that the bags 2 fit exactly between the transverse walls 8 and can thus not expand in their lower a while they are in the compartmented belt 6. Prior the bags 2 reaching the section of the parallel strand immediately preceding the conveyor belt 24, they lie still relatively safe with respect to the expanded space ween the transverse walls 8 thereat.

### List of Reference Numerals

1 Device

2 bag

3 collecting mechanism

4,5 guide roller

6 compartmented belt

7 feed-in station

8 transverse wall

9 normal

10 element

11 straight connecting line

12,13 axes of rotation

14 straight line

15 adjusting mechanism for angle α

16 adjusting mechanism for angle β

17 parallel strand

18 plug connection

19 mechanism for pivoting

20 locking device

21 pivot path

22 supply mechanism

23 detector

24 conveyor belt

25 carrier

What is claimed is:

1. A device for grouping of articles, in particular bags, which are delivered in groups to a collecting mechanism, comprising a compartmented belt rotating about guide rollers and having a plurality of transverse walls, into which compartmented belt is moved at a feed-in station one article between two transverse walls in order to be supplied to the collecting mechanism, wherein the transverse walls form a finite angle α with respect to a vertical of the elements, each of the elements effectively holding the transverse walls, wherein a straight line connecting axes of rotation at least two of the guide rollers of the compartmented belt and a straight line extending through one of the axes of rotation form a given angle β, and wherein these angles α and β, for the purpose of changing a distance d between two mutually adjacent transverse walls can be adjusted by means of an adjusting mechanism.

2. The device according to claim 1, wherein an exchangeable plug connection is provided as the adjusting mechanism for the angle α.

3. The device according to claim 2, wherein an angularly adjustable mounting for a transverse wall is provided as the adjusting mechanism for the angle α.

4. The device according to claim 1, wherein a mechanism for pivoting one axis of rotation about the other axis of rotation is provided as the adjusting mechanism for the angle β, which mechanism in addition has a locking device for fixedly locating the pivoted axis of rotation.

5. The device according to claim 1, wherein the transverse walls are designed rigidly.

6. The device according to claim 1, wherein the compartmented belt rotates in a vertical plane, and wherein the straight line is the vertical.

7. The device according to claim 6, wherein a continuously driven supply mechanism for supplying the articles is provided at the feed-in station, and wherein the transverse wall provided at the feed-in station is aligned parallel with respect to an article feed direction of the supply mechanism.

8. The device according to claim 1, wherein a detector for recognizing the supplied articles is provided at the feed-in station.
